(19) United States
(12) Patent Application Publication
(10) Pub. No.: US 2007/0090142 A1
(43) Pub. Date: Apr. 26, 2007

(54) CONCEALABLE RACK FOR CARRYING A BICYCLE ON A VEHICLE

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/163,533

(22) Filed: Oct. 21, 2005

(51) Int. Cl. B60P 9/00; B60R 11/00; B60R 9/00

(52) U.S. Cl. 224/496; 224/510; 224/924; 414/462

(57) ABSTRACT

There is disclosed a rack for carrying at least one bicycle on a vehicle. The rack includes at least one holding device for holding the bicycle and at least one pair of telescopic beams for supporting the holding device. The telescopic beams are put between a bumper and a portion of the vehicle. The rack is concealed in the vehicle as the telescopic beams are retracted. The rack is exposed from the vehicle as the telescopic beams are stretched.

### BACKGROUND OF INVENTION

1. Field of Invention

The present invention relates to a concealable rack for carrying a bicycle on a vehicle.

2. Related Prior Art

In U.S. Pat. No. 5,096,102, there is disclosed a carrier mounted on a license plate receiver of a motor vehicle. The carrier includes a vertical mounting plate 12 and a horizontal support plate 20 extended from the lower edge of the mounting plate 12. The mounting plate 12 and a license plate 14 are attached to the license plate receiver. The carrier includes other elements installed on the support plate 20. To carry a bicycle for example, the carrier is attached to the vehicle. When not in use, the carrier is moved from the vehicle for saving room. However, as the carrier includes many elements, its installation and un-installation require a lot of time and energy from a driver. This is not a humane design. In addition, when a bicycle is carried on the carrier, the turn signals and taillights of the vehicle are concealed by means of the bicycle. This is dangerous when the driver turns and brakes. This is especially dangerous at night.

The present invention is therefore intended to obviate or at least alleviate the problems encountered in prior art.

### SUMMARY OF INVENTION

According to the present invention, a There is disclosed a rack for carrying at least one bicycle on a vehicle. The rack includes at least one holding device for holding the bicycle and at least one pair of telescopic beams for supporting the holding device. The telescopic beams are put between a bumper and a portion of the vehicle. The rack is concealed in the vehicle as the telescopic beams are retracted. The rack is exposed from the vehicle as the telescopic beams are stretched.

An advantage of the rack of the present invention is that bicycles can be carried on the rack located between the bumper and the portion of the vehicle. The bicycles and the rack will not shade the license plate, the taillights and, if any, radars. Therefore, the safety of the vehicle and is ensured. It is especially so at night.

Another advantage of the rack of the present invention is that the rack can be concealed in the vehicle when the rack is not in use and exposed from the vehicle in order to carry the bicycles. The concealing and exposing are easy.

Still another advantage of the rack of the present invention is that the rack can be concealed in the vehicle when the rack is not in use. Hence, the rack will not be stolen, i.e., its security is ensured.

Other objectives, advantages and novel features of the present invention will become more apparent from the following detailed description referring to the attached drawings.

### BRIEF DESCRIPTION OF DRAWINGS

The present invention will be described via detailed illustration of the preferred embodiment thereof referring to the drawings.

FIG. 1 is a perspective view of a car equipped with a concealable rack according to the preferred embodiment of the present invention.

FIG. 2 is an enlarged partial view of the vehicle shown in FIG. 1 from which the concealable rack is exposed for carrying bicycles.

FIG. 3 is a rear view of the vehicle of FIG. 2 from which a bumper is removed in order to show how the concealable rack carries a bicycle.

FIG. 4 is similar to FIG. 3 but shows the bumper installed.

FIG. 5 is similar to FIG. 4 but shows the bicycle removed from the concealable rack and the concealable rack concealed in the vehicle.

### DETAILED DESCRIPTION OF PREFERRED EMBODIMENT

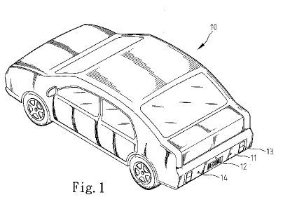

Referring to FIG. 1, a vehicle 10 is shown. Although concealed, a rack according to the preferred embodiment of the present invention is attached to the vehicle 10. The vehicle 10 includes a bumper 11 attached to the rack. A license plate 12 and several taillights 13 and radars 14 are installed on the bumper 11.

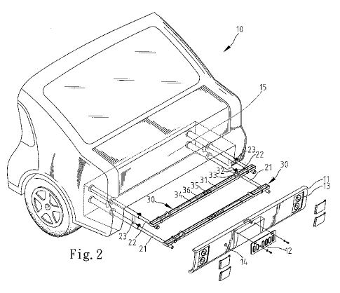

Referring to FIG. 2, the rack includes two lower telescopic beams 21 attached to a portion 15 of the vehicle 10, two upper telescopic beams 22 attached to the portion 15 and two connectors 23 for connecting the lower telescopic beams 21 to the upper telescopic beams 22. The bumper 11 is attached to the lower telescopic beams 21. A holding device 30 is installed on the lower telescopic beams 21. Another holding device 30 is installed on the upper telescopic beams 22.

The rack is provided between the bumper 11 and the portion 15 of the vehicle 10. When the rack is exposed from the vehicle 10 in order to carry bicycles, the rack and the bicycles will not shade the bumper 11, the license plate 12, the taillights 13 and the radars 14.

Each of the holding device 30 includes a crossbar 36 supported on the telescopic beams 21 or 22, a groove 31 defined in the crossbar 36, two shackles 32 movably installed on the crossbar 36, two stops 33 movably installed on the crossbar 36, a rod 34 pivotally connected to the crossbar 36 and a hook 35 connected to the rod 34.

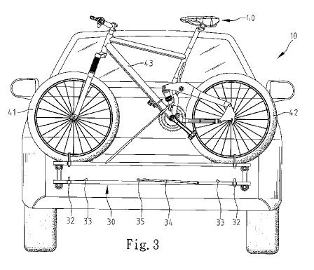

Referring to FIG. 3, a bicycle 40 is carried on the rack from which the bumper 11 is removed. Two bicycles can be carried on the rack since the rack includes two holding devices 30. In fact, more bicycles can be carried on the rack if the rack includes more pairs of telescopic beams and holding devices 30.

The bicycle 40 is held by means of the holding device 30 supported on the upper telescopic beams 22. The front wheels 41 and the rear wheels 42 of the bicycle 40 are put in the groove 31 defined in the crossbar 36 of the holding device 30. The wheels 41 and 42 are bound by means of the shackles 32. The wheels 41 are 42 are restrained between the stops 33. Each of the stops 33 includes a ramp (not numbered) for contact with the wheel 41 or 42. The rod 34 is pivoted from the crossbar 36 so that the hook 35 can reach and hook the down tube 43 of the bicycle 40. The rod 34 can be stretched and retained in any desired length. Hence, the bicycle 40 is held by means of the holding device 30 at five points.

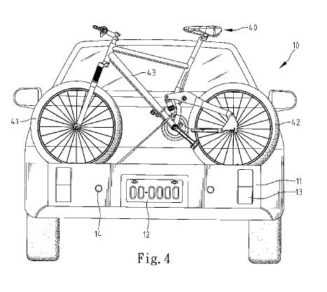

Referring to FIG. 4, the bicycle 40 is carried on the rack to which the bumper 11 is attached. The bicycle 40 and the rack will not shade the license plate 12, the taillights 13 and the radars 14.

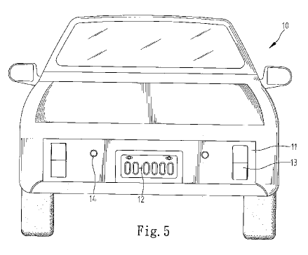

Referring to FIG. 5, the bicycle 40 is removed from the rack and the rack is concealed in the vehicle 10. The look of the vehicle 10 is not changed.

The rack of the present invention exhibits several advantages over the carrier discussed in the Related Prior Art.

Firstly, bicycles can be carried on the rack put between the bumper 11 and the portion 15 of the vehicle 10. The bicycles and the rack will not shade the license plate 12, the taillights 13 and the radars 14. Hence, the safety of the vehicle 10 is ensured. It is especially so at night.

Secondly, the rack can be exposed from and concealed in the vehicle 10. The exposing and concealing of the rack is as easy as maneuvering a drawer.

Thirdly, when not in use, the rack can be concealed in the vehicle 10. Hence, the rack will not be stolen, i.e., its security is ensured.

The present invention has been described via detailed illustration of the preferred embodiment. Those skilled in the art can derive variations from the preferred embodiment without departing from the scope of the present invention. Therefore, the preferred shall not limit the scope of the present invention defined in the claims.

What is claimed is:

1. A rack for carrying at least one bicycle on a vehicle, the rack comprising:
at least one holding device for holding the bicycle; and
at least one pair of telescopic beams for supporting the holding device on the vehicle;
a bumper connected to the telescopic beams so that the rack is concealed by means of the bumper as the telescopic beams are retracted and exposed from the vehicle as the telescopic beams are stretched;
a license plate attached to the bumper; and
a plurality of taillights attached to the bumper.

2. The rack according to claim 1 wherein the holding device comprises a crossbar for supporting the wheels of the bicycle.

3. The rack according to claim 2 wherein the crossbar defines a groove for receiving the wheels.

4. The rack according to claim 2 wherein the holding device comprises two shackles installed on the crossbar in order to hold the wheels.

5. The rack according to claim 4 wherein the holding device comprises a hook installed on the crossbar in order to hook the down tube of the bicycle.

6. The rack according to claim 5 wherein the holding device comprises a rod provided between the hook and the crossbar.

7. The rack according to claim 6 wherein the holding device comprises two stops installed on the crossbar in order to restrain the wheels.

8. The rack according to claim 2 wherein the holding device comprises a hook installed on the crossbar in order to hook the down tube of the bicycle.

9. The rack according to claim 8 wherein the holding device comprises a rod provided between the hook and the crossbar.

10. The rack according to claim 9 wherein the holding device comprises two stops installed on the crossbar in order to restrain the wheels.

11. The rack according to claim 2 wherein the holding device comprises two stops installed on the crossbar in order to restrain the wheels.

12. The rack according to claim 1 comprising a plurality of holding devices and a corresponding number of pairs of telescopic beams for support the holding devices.

13. The rack according to claim 1 comprising a plurality of radars attached to the bumper.
